(19) United States
(12) Patent Application Publication
(10) Pub. No.: US 2006/0094281 A1
(43) Pub. Date: May 4, 2006

(54) Latching electrical connector assembly

(75) Inventor: Phong T. Dang, Kent, WA (US)

Correspondence Address: STOEL RIVES LLP, 900 SW FIFTH AVENUE, SUITE 2600, PORTLAND, OR, 97204-1268, US

(73) Assignee: Carlyle, Inc., Tukwila, WA (US)

(21) Appl. No.: 11/267,220

(22) Filed: Nov. 4, 2005

Related U.S. Application Data
(60) Provisional application No. 60/625,367, filed on Nov. 4, 2004.

(51) Int. Cl. H01R 13/627

(52) U.S. Cl. 439/352

(57) ABSTRACT

A latch system for a connector assembly, such as an electrical or fiber-optic connector assembly, includes a latch arm extending from one connector housing for engaging a corresponding catch of a mating connector housing. Some embodiments include a pair of opposing latch arms that slidably seat in a pair of opposing slots in the housing of the mating connector. In one embodiment, the connector housings of plug and socket connectors are identical, with latch arms and catches being interchangeable. Some embodiments include tactile features for indicating that the latch system is securely latched.

### RELATED APPLICATIONS

The present application is related to and claims priority under 35 U.S.C. § 119(e) from U.S. Provisional Application No. 60/625,367 entitled “Spring Latch and Reconfigurable Backshell for Electrical Connector Assembly” and filed on Nov. 4, 2004, which is hereby incorporated by reference.

### TECHNICAL FIELD

The field of the invention relates to connector assemblies such as electrical connector assemblies and the like, and, in particular, to latching devices for such connector assemblies.

### SUMMARY

A latch system for a connector assembly, such as an electrical or fiber-optic connector assembly, includes a latch arm extending from one connector housing for engaging a corresponding catch of a mating connector housing. In one embodiment, the latch arms can be selectively installed on a connector housing of either a plug (male) connector or a socket (female) connector, with catch pins extending across corresponding lateral slots in a mating connector housing of a connector assembly of the opposite gender. Other than the latch arms and catch configuration, the connector housings of the plug and socket connector assemblies may be identical, with latch hooks and catch pins that are interchangeable. In another embodiment, each of the plug and socket connector assemblies may include both a latch arm that engages a catch of another connector housing and a catch that is engaged by an opposing latch arm of another connector housing. In such an embodiment, the connector housing and mating connector housings may be substantial mirror images.

Some embodiments include tactile features on the connector housing of a first connector and the latch arm of the mating connector which align when the latch system is securely latched to thereby provide tactile and/or visual feedback to a user.

### BRIEF DESCRIPTION OF THE DRAWINGS

FIG. 1 is a pictorial view of corresponding plug and socket connector assemblies, shown un-mated and omitting electrical cables terminated by the connector assemblies;

FIG. 2 is an exploded assembly view of the socket connector assembly of FIG. 1, shown from the rear;

FIG. 3 is a front view of the exploded socket connector assembly of FIG. 2;

FIG. 4 is a side pictorial view of the plug and socket connector assemblies of FIG. 1, shown mated;

FIG. 5 is a top pictorial view of the plug and socket connector assemblies of FIG. 1, shown mated; and

FIG. 6 is an enlarged rear pictorial view of the connector assemblies of FIG. 1, with a cable strain relief portion of one or the connector housings exploded to show detail thereof.

### DETAILED DESCRIPTION OF PREFERRED EMBODIMENTS

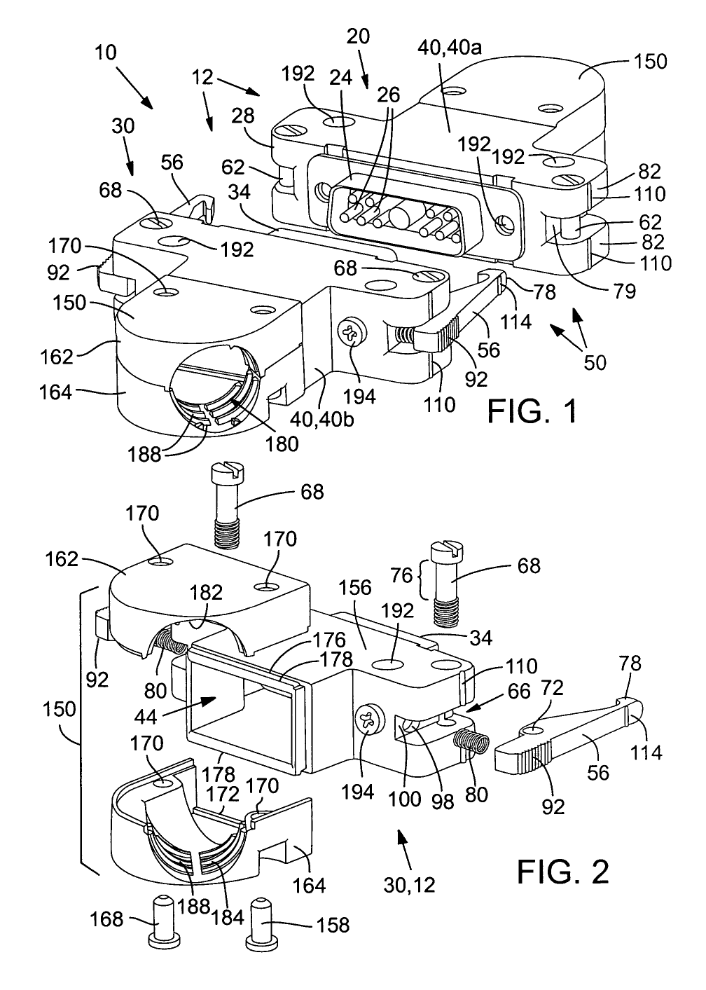

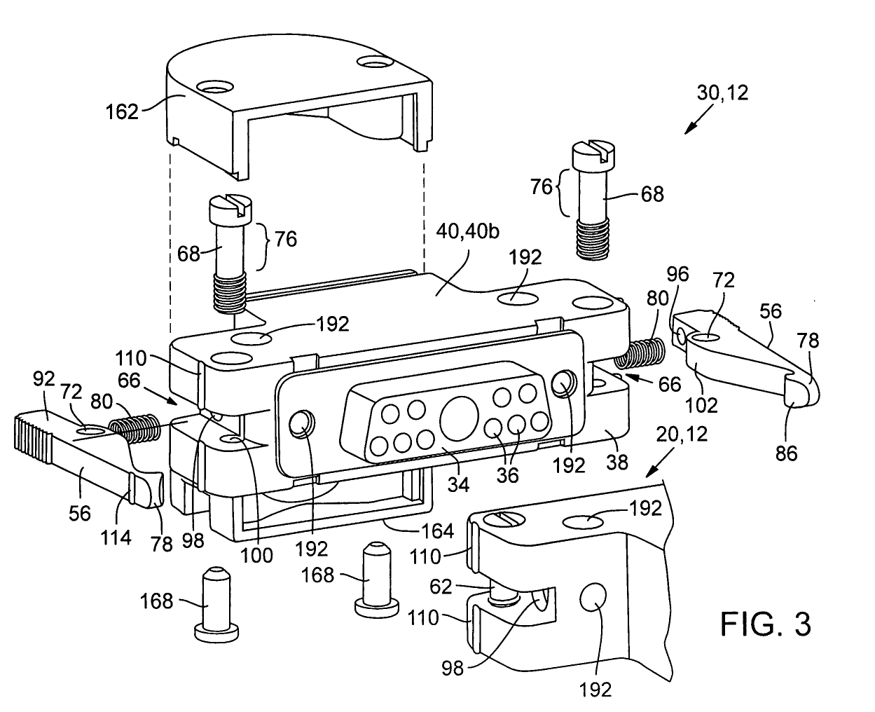

FIG. 1 is a pictorial view of an electrical connector system 10 in accordance with a first embodiment, including a pair of mating electrical connector assemblies 12 shown un-mated. For clarity, electrical cables terminated by the connector assemblies 12 are omitted from the figures. With reference to FIG. 1, a male plug connector assembly 20 includes a male connector body 24 supporting multiple male contacts 26, and a female socket connector assembly 30 includes a female connector body 34 supporting multiple female contacts 36 (FIG. 3). Connector bodies 24 and 34 are seated in connector openings (not numbered) in mating faces 28 and 38 (FIG. 3) of housings 40a and 40b. Housings 40a and 40b may be identical and capable of supporting either male or female connector bodies 24 or 34, and hereinafter may be referred to generically as housings 40 or backshells. Connector bodies 24, 34 extend from mating faces 28, 38 of the respective connector assemblies 20, 30 rearward in the cable exit direction through the connector openings of the housings 40 and at least partly into interior cavities 44 (FIG. 2) of housings 40. Connector housings 40 may each be formed of one-piece construction; however, in alternative embodiments, housings 40 may comprise two or more sections joined along parting lines, for ease of manufacture or repair.

For convenience, certain embodiments are described herein in the context of electrical connector assemblies, such as the D-Sub connectors illustrated in the drawings. However, as will become apparent from the following disclosure, the embodiments described herein may be implemented with different kinds of connectors and coupling devices.

### Latch Device

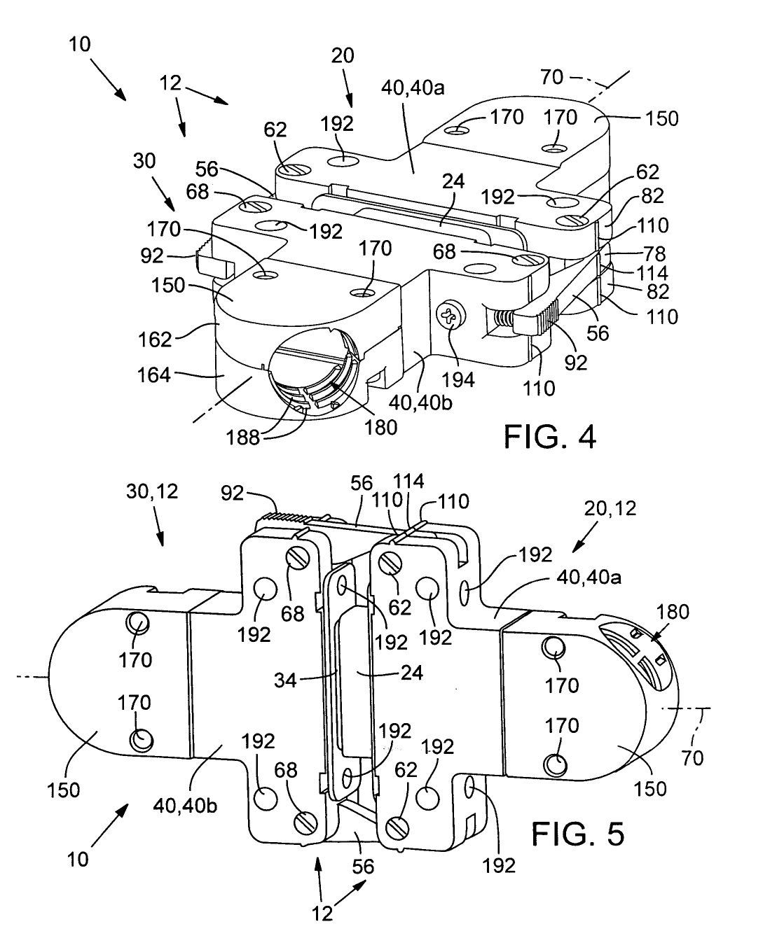

With reference to FIGS. 1-6, a latch device 50 for positively latching together plug and socket connector assemblies 20 and 30, comprises a pair of opposing latch arms 56 in one of the connector assemblies 12 for releasably engaging a corresponding pair of catches 62 of a mating side of one of the connector assemblies. FIGS. 4 and 5 show connector assemblies 20 and 30 mated, with latch device 50 latched. The latch device 50 is illustrated in the Figures with latch arms 56 projecting from mating face 38 of socket connector assembly 30 and with catches 62 installed on plug connector assembly 20.

However, latch arms 56 and catches 62 may be interchangeable, to allow reversal of the arrangement shown, or for each connector housing 40 to have both a latch arm and a catch. In the latter embodiment, one connector housing 40 may have both a catch 62 and a latch arm 56. As such, a connector housing 40 may both engage a catch 62 of another connector housing 40 and be engaged by a latch arm 56 of another connector housing 40. Such an arrangement indicates that the mirror image of connector housing 40 may mate with connector housing 40.

With particular reference to FIG. 2, connector housing 40 includes a pair of lateral slots 66 located along opposite sides of connector housing 40 and of connector body 24, 34 and extending generally parallel to a mating axis 70 (FIGS. 4-5) of connector assemblies 20, 30. Latch arms 56 may be pivotably retained in slots 66, and may be rotatably fastened by screws 68 pins, bolts, or other devices (68). Pivot screws 68 extend through pivot holes 72 in latch arms 56 and may include a smooth shank portion 76 to reduce friction when latch arms 56 are pivoted. Each of the latch arms 56 may include a distal hook end 78 projecting from connector housing 40. A spring 80 or other biasing device may engage connector housing 40 and latch arm 56 to bias latch arms 56 relative to housing 40 so that the hook ends 78 are biased toward each other. Such biasing may retain latch arms 56 in engaged connection with catches 62 until disengagement.

Within the scope of this disclosure, latch arms 56 may alternatively be formed as extensions of a connector housing 40 without being either pivotable or retained within slots 66. For instance, extension of latch arms 56 could be molded of one-piece construction with housing 40 of a material sufficiently flexible so as to allow latch arms 56 to bend when engaging catches 62 of a corresponding mating connector. As discussed previously, each connector assembly may include both a catch 62 and a latch arm 56 to mate with a mirror image of itself. Therefore, such a connector housing 40 may include only one slot 66 having a catch 62 therein, and a separate, opposing latch arm 56 extending from connector housing 40. Substantially the mirror image of such a connector housing 40 may mate with such a connector housing 40.

With further reference to FIGS. 1-3, hook ends 78 are sized to slide into open ends 79 of lateral slots 66 of a mating connector housing 40 for latching with corresponding catches 62. Catches 62 may comprise latch pins or the same kind of screws 68 with smooth shanks 76 as are used to rotatably mount latch arms 56. Latch pins or screws 68 may extend transversely of the mating axis 70 and may span lateral slots 66 or merely extend partway into slots 66. Catches 62 may alternatively comprise press pins or any other structure that can be engaged by latch arms 56, such as a transverse groove or other catch feature. Catches 62 may be recessed in lateral slots 66, being set back from mating face 28 and also set back from an outer side surface 82 of housing 40a, so that when connector assemblies 20 and 30 are mated, the hook ends 78 of latch arms 56 slide partly into open ends 79 of slots 66 before engaging catches 62. Thus, lateral slots 66 provide a lead-in and guide for latch arms 56 to facilitate blind mating and engagement in dark or hard to reach places, for example.

Hook ends 78 may include inner-tapered surfaces 86 (FIG. 3) including ramps to facilitate sliding movement over latch pins of catches 62. Latch device 50 may also include a spring-driven latching action that generates an audible click indicating positive latching when the hook ends 78 clear the latch pins of catches 62. Latch arms 56 include release tab portions 92 that may extend rearward of pivot screws 68 and may be depressed to release latch device 50 before decoupling (or disengaging) connector assemblies 20 and 30. Tab portions 92 may include gripping grooves to provide tactile indication of the location of tab portions 92, which may be located in a blind spot or in the dark for depression and disengagement of latch arms 56 from catches 62, allowing disconnection of mating connector bodies 24 and 34.

Springs 80 may be retained at one end thereof in depressions 96 (FIG. 3) formed along an inside surface of depressible tab portions 92, and at the other end thereof in opposing recesses 98 (FIGS. 2 and 3) formed along the base or inner side 100 of slots 66 in connector housing 40. Latch arms 56 each may include a flat shoulder 102 (FIG. 3) proximal to pivot hole 72 that rests against base 100 of slot 66 to set the minimum distance between hook ends 78, thereby facilitating connection with a mating connector assembly 12 and preventing over rotation of latch arms 56 and loss of springs 80 when connector assemblies 12 are disengaged.

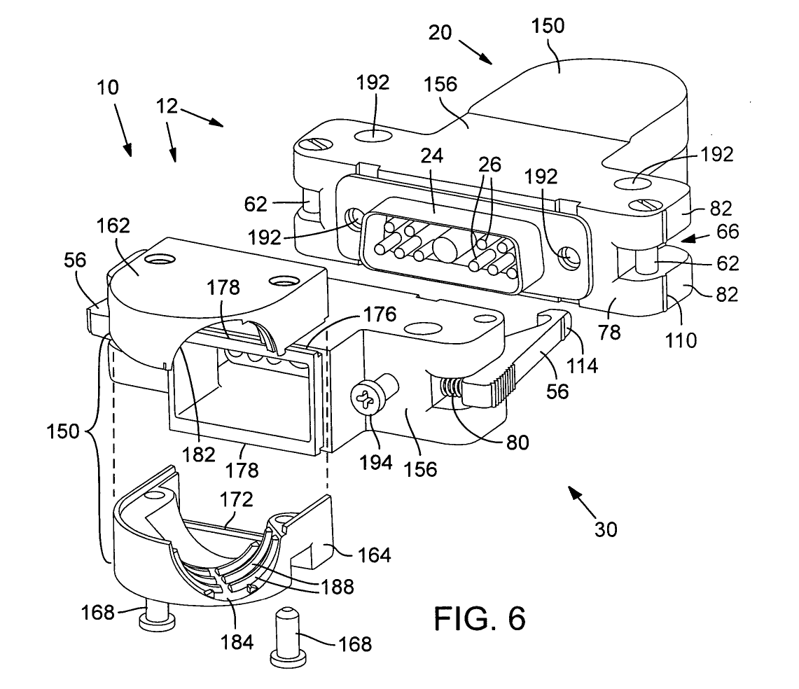

Latch device 50 may also provide audible, visible, and/or tactile feedback when the connectors are properly mated and the spring latches engage. One or more housing ribs 110 or other tactile and/or visible features may be positioned along outer side surfaces 82 of connector housings 40, which may include two such features in alignment and straddling slots 66. Corresponding latch ribs 114 or other tactile and/or visible features may be provided along outer surfaces of latch arms 56 of a mating connector assembly 12 near hook ends 78, and positioned so that when spring latch device 50 is properly engaged and securely latched, housing ribs 110 and latch ribs 114 of mating connector assemblies 20 and 30 are aligned, as shown in FIGS. 4 and 5, with the ribs 110 and 114 preferably being flush. (Latch ribs 110 and housing ribs 114 are omitted from FIG. 6.) Thus, latch ribs 114 may align with and cooperate with housing ribs 110 so as to be easily felt with a user's fingers to provide a form of tactile feedback that confirms secure and positive latching. Conversely, any misalignment of latch ribs 114 and housing ribs 110 may alert a user to the existence of incomplete or improper mating or latching. Alignment of latch ribs 114 and housing ribs 110 may also provide a form of visible confirmation of positive latching and complete engagement of connectors. In alternative embodiments, ribs 110, 114 may comprise other tactile and/or visible features, such as slots or bumps, for example.

### Reconfigurable Backshell and Strain Relief

In another aspect, the connector housing includes a reconfigurable strain relief that is connected to a main backshell portion of the connector housing in one of multiple predetermined positions that define discrete, angularly offset exit paths for a cable (e.g. electrical cable) or wires that terminate at the connector body. The strain relief may thereby be configured and reconfigured in the field to accommodate routing of the cable away from the connector assembly in any direction desired. The strain relief may include a pair of first and second mating clamshell sections that are joined together around the cable by pins, screws, or other fasteners generally rearward of the connector body and the main backshell portion. To provide a positive connection with the main backshell portion, the clamshell sections may also include inwardly-extending lip sections that engage one or more grooves or outwardly-extending flanges of the main backshell portion along its cable-exit end or around a cable-exit opening thereof.

A cable-engaging collar formed by the joinder of the first and second clamshell sections may be sized to securely grasp the cable and thereby prevent the cable or individual conductors thereof from being pulled loose from the connector body. The positions of the first and second clamshell sections can be switched to reverse the cable exit path. The strain relief and main backshell portion may be made of die cast or molded metal to inhibit electromagnetic interference (EMI shielding). The strain relief may be used with many different sizes of main backshell portion (for different sizes and types of connectors), resulting in reduced manufacturing costs by simplifying product design and reducing part inventories required for different sizes and types of connector assemblies.

With reference primarily to FIGS. 2 and 6, housing 40 may include a reconfigurable strain relief 150 connected to a main backshell portion 156 of housing 40. Strain relief 150 may comprise a pair of first and second mating clamshell sections 162 and 164 that are joined together around a cable (not shown) by a pair of press pins 168, screws, or other fasteners that extend through or into holes 170 in clamshell sections 162 and 164. Clamshell sections 162 and 164 may include inwardly extending lips 172 that engage one or more grooves 176 or outwardly extending flanges 178 along a cable exit end of main backshell portion 156, to provide a secure connection between strain relief 150 and main backshell portion 156. A cable engaging collar 180 (FIGS. 1, 4, and 5) may be formed by the joinder of clamshell sections 162 and 164, comprising a pair of opposing inner concave surfaces 182 and 184 of clamshell sections 162 and 164. Collar 180 is sized to securely engage a cable exiting connector assembly 12 and prevent wires of the cable from being pulled loose from the connector body 24 or 34. Collar 180 may include ridges 188 for biting into a cable's insulation, for improved cable engagement and strain relief.

Clamshell sections 162 and 164 are interchangeable and reversible for changing the exit path of the cable. Clamshell sections 162 and 164 may also be used with many different sizes of main backshell portion 156 (for different sizes and types of connectors), which may reduce manufacturing costs by simplifying product design and reducing part inventories required for different sizes and types of connector assemblies. Other reconfigurable strain relief structures may also be used with connector assemblies 12. An example of other designs for a reconfigurable strain relief is described in co-pending U.S. patent application Ser. No. 10/764,402, filed Jan. 23, 2004, and titled “Electrical Connector Assembly with Reconfigurable Strain Relief,” the disclosure of which is incorporated herein by reference.

Main backshell portion 156 and clamshell sections 162 and 164 of strain relief may be made of metal or another electrically or magnetically conductive material to provide EMI shielding (i.e. to inhibit electromagnetic interference). Preferred materials include die cast aluminum alloy 380 or die cast zinc alloy ZAMAK 3. However, housing 40 may also be formed of machined or injection molded metal, plastic, or other materials.

Connector housings 40 may include various mounting holes 192 and mounting screws 194 for retaining connector bodies 24, 34 to housings 40, for connecting connector assemblies 12 to mounting structures, such as printed circuit boards or patch panels, and for coupling a pair of mating connectors together.

It will be obvious to those having skill in the art that many changes may be made to the details of the above-described embodiments without departing from the underlying principles of the disclosure. For example, alternative embodiments (not shown) may be implemented with optical fiber couplings and connectors, and with other kinds of data transmission cables or power transmission cables. Embodiments of the latch device 50 may also be employed in connectors for coupling other rigid, semi-rigid, or flexible objects such as printed circuit boards, flex circuits, and other non-cable items. Consequently, while the embodiments described herein make reference to connectors for electrical cables and wires, nothing herein should be construed to limit the invention to electrical cables or wires. The scope of the present invention should, therefore, be determined only by the following claims.

1. A cable connector for mating with a corresponding mating connector along a mating axis, comprising:
a connector housing having a mating face that faces the mating connector when the cable connector and the mating connector are mated, the connector housing defining opposing first and second lateral slots extending away from the mating face and the mating connector, the first and second lateral slots aligned with the mating axis;
a first pin extending into the first lateral slot transversely of the mating axis; and
a second pin extending into the second lateral slot transversely of the mating axis.

2. The cable connector of claim 1, wherein each of the first and second lateral slots includes an open end proximal of the mating face.

3. The cable connector of claim 1, wherein the first and second pins are recessed from the mating face.

4. The cable connector of claim 1, wherein the connector housing includes a rib adjacent the first lateral slot and proximal of the first pin, the rib positioned to cooperatively align with a corresponding latch rib of a latch arm of the mating connector when mated to the cable connector to thereby indicate that the latch arm is securely latched to the first pin.

5. The cable connector of claim 1, further comprising a first latch arm pivotably attached to the first pin and supported in the first lateral slot, the first latch arm having a first latching end projecting from the connector housing beyond the mating face for latching engagement with the mating connector.

6. The cable connector of claim 5, further comprising a second latch arm pivotably attached to the second pin and supported in the second lateral slot, the second latch arm having a second latching end projecting from the connector housing beyond the mating face for latching engagement with the mating connector.

7. The cable connector of claim 6, wherein each of the first and second latching ends includes a hook for engaging a corresponding catch of the mating connector when the cable connector and the mating connector are mated.

8. The cable connector of claim 7, wherein each of the hooks has an inner-tapered surface to facilitate sliding movement over a corresponding latch pin of the mating connector.

9. The cable connector of claim 6 further comprising:
a first spring interposed between the first latch arm and the connector housing for biasing the first latching end relative to the connector housing; and
a second spring interposed between the second latch arm and the connector housing for biasing the second latching end relative to the connector housing.

10. The cable connector of claim 5, wherein the first latch arm includes a release tab that is manually depressed to pivot the first latch arm and release its engagement with the mating connector, thereby allowing the cable connector and the mating connector to be unmated.

11. In combination with the cable connector of claim 1, a mating connector adapted to be mated with the cable connector along the mating axis, the mating connector supporting first and second opposing latch arms extending outwardly from the mating connector and configured to slidably engage with the respective first and second lateral slots of the cable connector and to latch with the respective first and second pins.

12. A latch assembly for a pair of cable connectors matable together along a mating axis, comprising:
a first connector housing having a first mating face;
a second connector housing having a second mating face, the first and second mating faces facing each other when the cable connectors are mated;
a first lateral slot in the first connector housing extending generally parallel to the mating axis;
a first catch located in the first lateral slot and being recessed from the first mating face;
a first latch arm mounted to the second connector housing and extending outward from the mating face of the second connector housing for sliding engagement in the first lateral slot when the cable connectors are mated, the first latch arm having a distal end configured to releasably latch with the first catch;
a second lateral slot in one of the first and second connector housings and extending generally parallel to the mating axis;
a second catch located in the second lateral slot and being recessed from the mating face of said one of the first and second connector housings; and
a second latch arm mounted to the other of the first and second connector housings and extending outward from the mating face thereof for sliding engagement in the second lateral slot when the cable connectors are mated, the second latch arm having a distal end configured to releasably latch with the second catch.

13. The latch assembly of claim 12, wherein each of the first and second latch arms is pivotably mounted to its corresponding connector housing by a pivot pin.

14. The latch assembly of claim 12, further comprising:
a first rib on an outer surface of the first connector housing adjacent the first lateral slot; and
a second rib located on the distal end of the first latch arm, the first and second ribs being aligned when the cable connectors are properly mated, thereby providing tactile indication that the latch assembly is securely latched.

15. The latch assembly of claim 12, wherein each of the latch arms includes a hook at its distal end for engagement with the corresponding catch.

16. The latch assembly of claim 12, wherein the first catch comprises a first latch pin, the second catch comprises a second latch pin, and the distal end of each latch arm is tapered so as to slide over the respective latch pin and thereby facilitate mating of the cable connectors.

17. The latch assembly of claim 12, wherein the distal end of the first latch arm is biased toward the first catch, and the distal end of the second latch arm is biased toward the second catch.

18. A latch assembly for a cable connector and a mating connector matable to the cable connector, comprising:
a first connector housing having a first mating face;
a second connector housing having a second mating face, the first and second mating faces facing each other when the cable connector and mating connector are mated, and the second connector housing including a catch and a first tactile feature proximal of the catch; and
a latch arm supported on the first connector housing and having a first latching end projecting from the first connector housing beyond the first mating face for latching engagement with the catch of the second connector housing when the cable connector and mating connector are mated, the latch arm further including a second tactile feature that aligns with and cooperates with the first tactile feature when the cable connector and mating connector are properly mated to thereby provide tactile indication to a user that the latch assembly is securely latched.

19. The latch assembly of claim 18, wherein the first and second tactile features comprise respective first and second ribs that align flush when the latch assembly is securely latched.

20. The latch assembly of claim 18, wherein the catch comprises a latch pin.
